(19) United States
(12) Patent Application Publication
(10) Pub. No.: US 2007/0076708 A1
(43) Pub. Date: Apr. 5, 2007

(54) Error protection techniques for frames on a wireless network

(76) Inventors: Mikolaj Kolakowski, Reda (PL); Jacek Wysoczynski, Banino (PL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/241,339

(22) Filed: Sep. 30, 2005

(51) Int. Cl. H04L 12/56

(52) U.S. Cl. 370/389; 370/473

(57) ABSTRACT

Techniques for use of forward error correction (FEC) that may be applied to wireless data packets that may result in reduce errors, which in turn may result in fewer dropped packets and/or retransmissions to provide better multimedia transmission than current techniques.

### TECHNICAL FIELD

Embodiments of the invention relate to wireless transmissions. More particularly, embodiments of the invention relate to techniques to provide error protection for multicast frames transmitted using a wireless communications protocol.

### BACKGROUND

When transmitting certain types of data (e.g., audio and/or video data) reliability of the transmission is important. For example, when transmitting multimedia data, the loss or corruption of a packet may result in inferior playback quality. When the transmission media is lossless or nearly lossless multimedia transmission can be accomplished without error correction or detection mechanisms.

Because wireless network access has become increasingly popular demand has increased for wireless transmission of multimedia data. However, wireless transmission is not lossless and current protocols may either drop or retransmit packets. This results in inconsistent and possibly inferior transmission of multimedia data.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of one embodiment of topology of a network over which data may be transmitted over a wireless network.

FIG. 2 illustrates one embodiment of a frame configuration that may be used to support FEC in wireless transmissions.

FIG. 3 illustrates one embodiment of interleaving that may be used to support wireless FEC transmissions.

FIG. 4 is a flow diagram of one embodiment of a technique for application of forward error correction (FEC) to a packet to be transmitted via a wireless transmission protocol.

FIG. 5 is a flow diagram of one embodiment of a technique for application of forward error correction (FEC) to a packet to be received via a wireless transmission protocol.

FIG. 6 is a block diagram of one embodiment of an electronic system.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description. The description that follows is presented in terms of packets of data that may be transmitted using wireless communications protocols. The term “packet” is intended to generically refer to blocks of data and may also be referred to as, for example, frames, cells, etc.

As described in greater detail below, techniques for use of forward error correction (FEC) may be applied to wireless data packets that may result in reduce errors, which in turn may result in fewer dropped packets and/or retransmissions to provide better multimedia transmission than current techniques. In one embodiment the FEC may be applied at the media access control (MAC) network layer. In one embodiment, transmission is accomplished using an IEEE 802.11 protocol (e.g., 802.11b and/or 802.11g), which does not have an error correction mechanism defined in the standard.

IEEE 802.11b corresponds to IEEE Std. 802.11b-1999 entitled “Local and Metropolitan Area Networks, Part 11: Wireless LAN Medium Access Control (MAC) and Physical Layer (PHY) Specifications: Higher-Speed Physical Layer Extension in the 2.4 GHz Band,” approved Sep. 16, 1999 as well as related documents. IEEE 802.11g corresponds to IEEE Std. 802.11g-2003 entitled “Local and Metropolitan Area Networks, Part 11: Wireless LAN Medium Access Control (MAC) and Physical Layer (PHY) Specifications, Amendment 4: Further Higher Rate Extension in the 2.4 GHz Band,” approved Jun. 27, 2003 as well as related documents.

When using IEEE 802.11 transmission standards, to transmit a multimedia (e.g., video) stream at approximately 1 Megabit per second (Mbps), transmission bandwidth (11 Mbps for IEEE 802.11b and 54 Mbps for IEEE 802.11g) is not fully utilized by transmission of the multimedia stream. As described in greater detail below, a portion of this unused bandwidth may be used for FEC purposes.

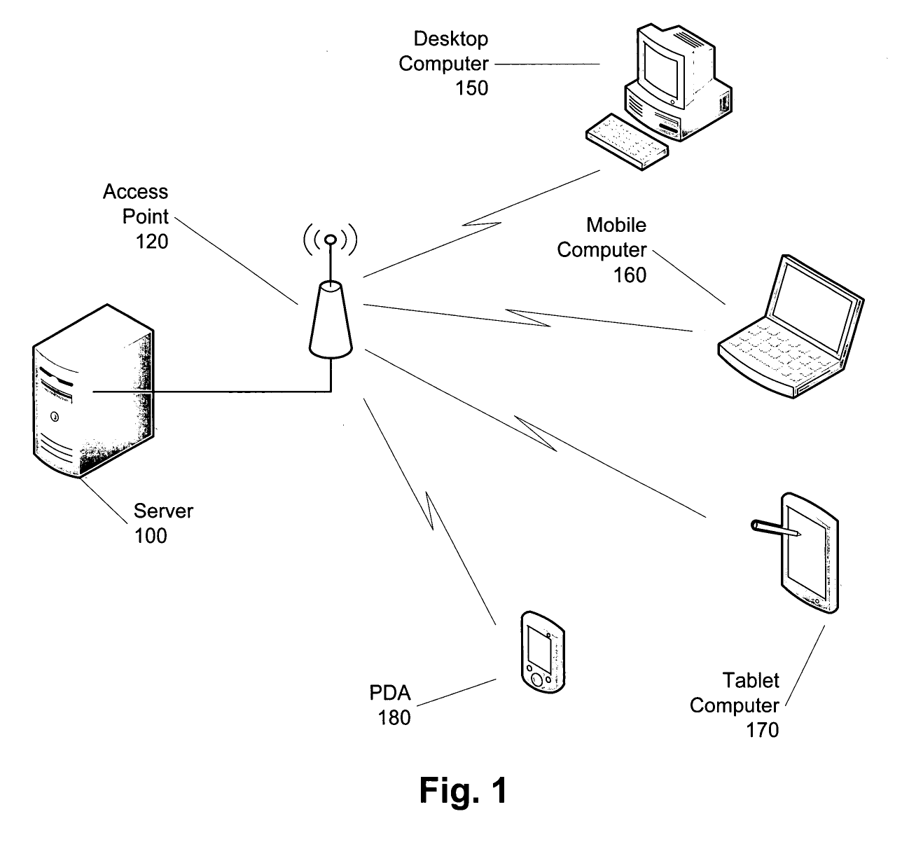

FIG. 1 is a block diagram of one embodiment of topology of a network over which data may be transmitted over a wireless network. The topology of FIG. 1 is intended to represent many different types of network configurations that include any number of devices, only a small sampling of which are illustrated in FIG. 1.

Server 100 may be coupled to provide data to any number of client devices over one or more wired and/or wireless communications links. In one embodiment, at least one of the communications links may include a wired connection to a wireless access point (e.g., access point 120), which may transmit data to one or more remote devices using a wireless communications protocol.

In one embodiment, access point 120 may communicate with client devices by conforming to IEEE 802.11b and/or IEEE 802.11g standards. Other wireless network interfaces and/or protocols can also be supported. Any number of client devices that are capable of communicating using wireless protocols may communicate with access point 120.

The client device may include, for example, desktop computer 150, mobile computer 160, tablet computer 170 and/or personal digital assistant (PDA) 180. As described in greater detail below, data transmitted by access point 120 may have a forward error correction (FEC) code applied that may allow reduction or even elimination of retransmissions of multicast data. In one embodiment, the data multicast by access point 120 may be multimedia data; however, the FEC techniques described herein are not limited to multimedia and/or multicast transmissions.

In one embodiment, access point 120 communicates with one or more client devices (generically referred to as “wireless stations” or “STAs”) to agree during an association phase to use FEC for selected transmission (e.g., multicast transmissions, multimedia transmissions). Various techniques for providing an association phase is known in the art and generally refer to a period during which a STA detects a nearest/strongest access point and associates itself with the access point for communication purposes by exchanging information with the access point. The agreement to use FEC for selected transmissions may be accomplished, for example, as an information element in an Association Request.

In one embodiment server 100 may transmit multimedia data to access point 120 using a wired protocol, for example, IEEE 802.3. In one embodiment, using IEEE 802.3, data may be transmitted in 16-kb packets. Other wired transmission protocols may also be used. IEEE 802.3 corresponds to IEEE Std. 802.3-2002 entitled “Local and Metropolitan Area Networks, Part 3: Carrier sense multiple access with collision detection (CSMA/CD) access method and physical layer specifications,” approved Mar. 8, 2002 (which is a revision of IEEE Std. 802.3, 2000 edition) as well as related documents.

In one embodiment, access point 120 may segment the packets received from server 100 into smaller blocks (e.g., 1.5 kb, 3 kb, 8 kb, or any other size). The fragments may be protected using error correction code (ECC), for example FEC. In general, FEC refers to techniques of obtaining error control in data transmission in which the transmitter may send redundant data and the receiver(s), or STAs, may recognize only the portion of the data that contains no apparent errors. Because FEC does not require handshaking between the transmitter and the STAs, FEC may be used for multicasting or broadcasting of data to many destinations simultaneously from a single source.

In an example simple form of FEC, each block of data may be sent twice. The STA may check both instances of each block of data for adherence to the protocol being used. If conformity occurs in both instances, the block of data may be accepted. If conformity occurs in one instance and not in the other, the block of data that conforms to protocol may be accepted. If conformity does not occur in either instance, the block of data may be rejected. Other types of FEC techniques may also be used.

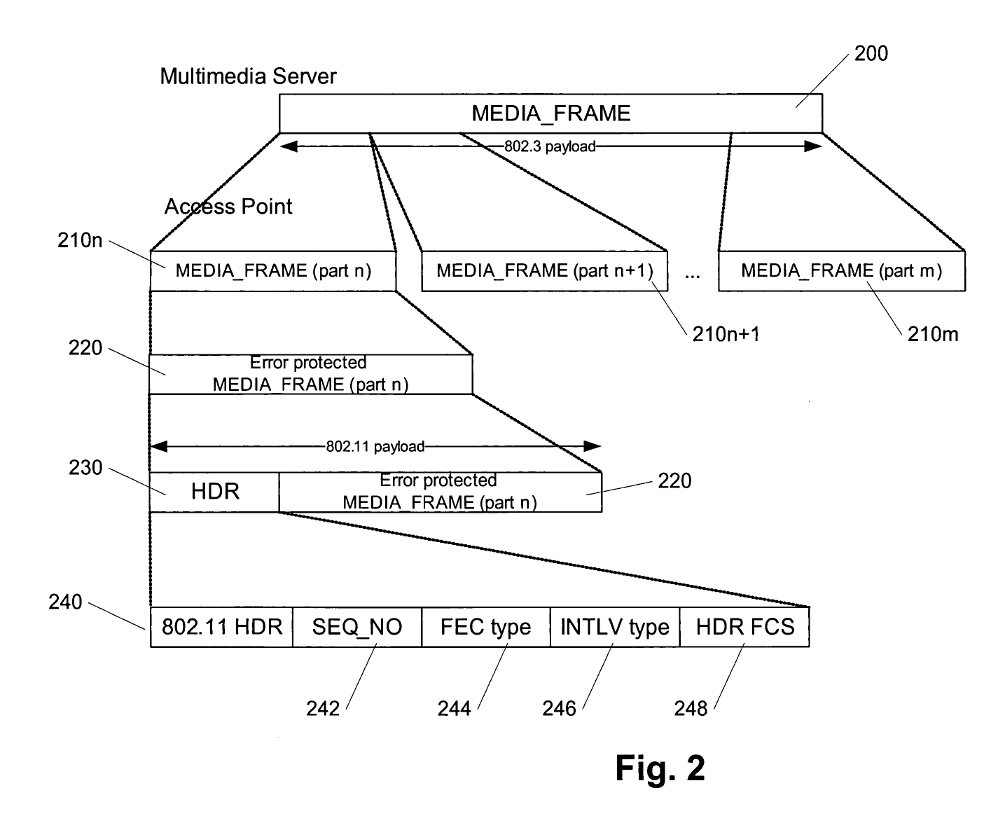

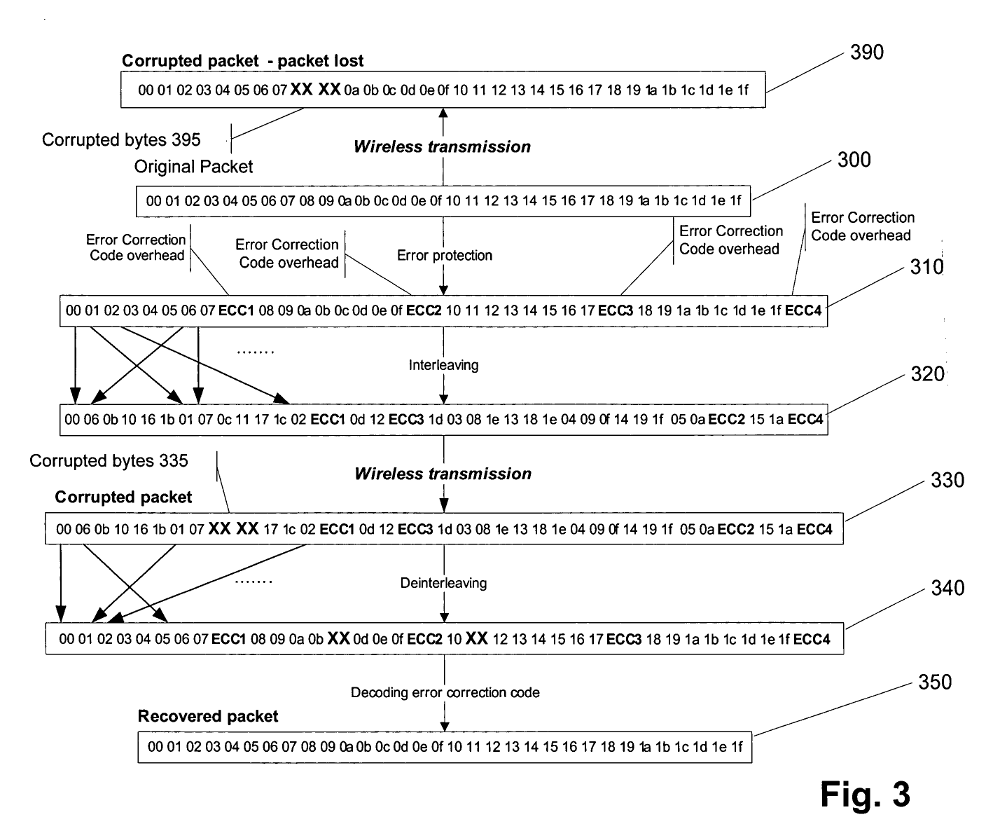

Access point 120 may interleave the FEC-protected segments. One embodiment of segment interleaving is described in greater detail with respect to FIGS. 2 and 3. More specifically, FIG. 2 illustrates one embodiment of a frame configuration that may be used to support FEC in wireless transmissions. As described above, a frame of data to be transmitted (labeled “Media Frame 200” in FIG. 2) may be received over a wired connection (e.g., IEEE 802.3). While frame 200 is labeled as a media frame and may be used to transmit multimedia data, other types of data may also be transmitted using the techniques described herein. Frame 200 may be transmitted by a server (e.g., server 100) or other network entity.

The access point, or other network entity, may break frame 200 into two or more segments (e.g., media frame part 210n, media frame part 210n+1, media frame part 210m). In one embodiment each of the segments (or media frame parts) may be transformed to an error protected segment (e.g., error protected media frame part) 220. Header 230 may be added to error protected media frame part 220 to result in a payload that conforms with an IEEE 802.11 standard or another wireless transmission standard.

In one embodiment, header 230 may include one or more fields that may be used by the STAs to process the received fragments. In one embodiment, header 230 may include standard 802.11 header information (if the 802.11 standard is being used) 240. Header 230 may further include sequence number (SEQ_NO) field 242, FEC type field 244, interleave type (INTLV type) field 246 and/or header FCS (HDR FCS) field 248.

In one embodiment, sequence number field 242 may carry a number that indicates the relationship of the current frame to other frames in the data stream. FEC type field, 244 may provide information related to the type of FEC used with the frame of data. Interleave type field 246 may provide information to indicate the type of data interleaving use with the frame. Header FCS 248 field may carry information that may be used to be used for verification of the header information as a whole. FCS field 248 may be used to protect the additional header information inserted by the access point. The packet may be interleaved with other packets and transmitted.

FIG. 3 illustrates one embodiment of interleaving that may be used to support wireless FEC transmissions. In one embodiment, segments (as described above) are interleaved on a byte-by-byte basis; however, other interleaving strategies may also be supported.

Original packet 300 represents a segment of data that corresponds to a portion of a received data packet (e.g., a multimedia Ethernet packet). Corrupted packet 390 represents a packet in which a byte of data has been corrupted, for example, lost during wireless transmission of original packet 300. Corrupted bytes 395 are indicated by “XX XX” rather than the original “08 09” in original packet 300. In the example that follows a technique of forward error correction (FEC) may be applied to original packet 300 such that corrupted bytes may be recovered.

In one embodiment, error correction code (ECC) overhead bytes (e.g., ECC1, ECC2, ECC3, ECC4) may be added to original packet 300 to generate error protected packet 310. In one embodiment, one ECC byte may be used to correct one byte of error in nine consecutive bytes of data. Other ECC techniques may also be used. One embodiment of byte interleaving is illustrated in FIG. 3 in which bytes form error protected packet 310 are interleaved to generate interleaved packet 320, which includes the ECC bytes interleaved with the original data bytes from original packet 300.

Interleaved packet 320 may be transmitted using a wireless protocol. During wireless transmission one or more bytes may become corrupted, 335. Corrupted packet 330 may be deinterleaved by the receiving device to generate deinterleaved packet 340, which may contain corrupted data. Because deinterleaving distributes the corrupted bytes ECC bytes may be used to recover the original data if the number of corrupted bytes does not exceed the protection capacity of the ECC technique used. Using the ECC bytes recovered packet 350 may be generated from deinterleaved packet 340.

Thus, available bandwidth may be used to support real-time multimedia broadcast traffic on the MAC layer. Currently, applications (if any) perform retransmissions on higher layers, which causes greater latency (with the use of multicast or unicast traffic). The technique described herein resolves a gap in the IEEE 802.11 standards, which do not provide retransmission mechanisms for multicast/broadcast traffic.

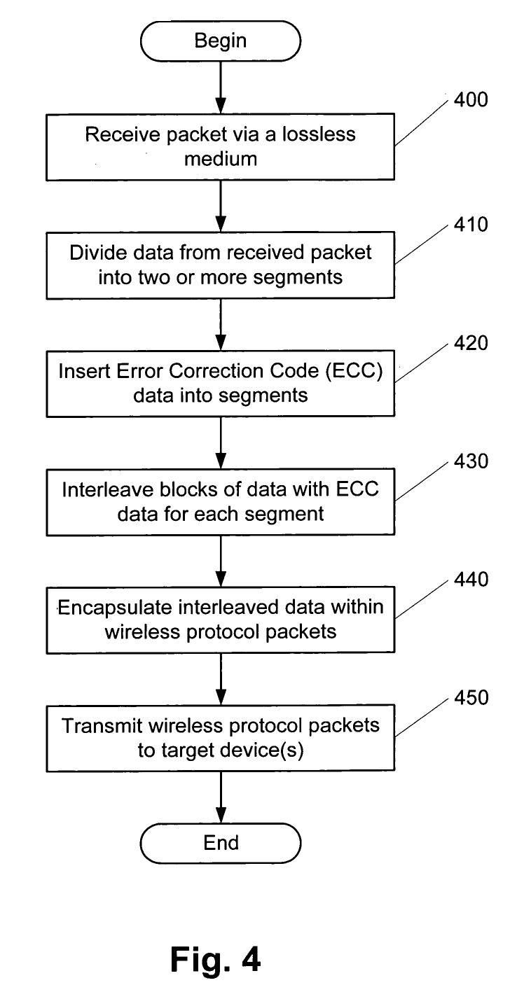

FIG. 4 is a flow diagram of one embodiment of a technique for application of forward error correction (FEC) to a packet to be transmitted via a wireless transmission protocol. A packet to be transmitted may be received via a lossless communications medium, 400. The lossless communications medium may be a wired communications medium such as, for example, a wired Ethernet connection between a server and a wireless access point. The lossless communications medium may also be, for example, a bus or other wired communications medium within a device having wireless communications capability. It should be noted that the term “lossless” does not require absolute absence of data loss; rather it refers to a generally lossless or reliable communications medium.

The data from the original packet may be divided into two or more segments, 410. These data segments may be any size smaller than the original data packets. Transmission of smaller data packets allows addition of ECC data that may be used to recover lost or corrupted data. The segmented data may have ECC data added, 420. In one embodiment one byte of ECC data is added to the segment for each nine bytes of data to be transmitted. Alternate ECC techniques may also be used.

The combined segmented data and ECC data may be interleaved, 430, as described above with respect to FIG. 3. The interleaved segmented and ECC data may be encapsulated in a data packet according to the wireless transmission protocol (e.g., IEEE 802.11 b/g), 440. The encapsulated data may be transmitted to one or more target devices using the wireless protocol, 450. The transmission technique may be particularly useful in multicasting and/or broadcasting of multimedia data to, for example, reduce conditions that may require retransmission and/or loss of packets.

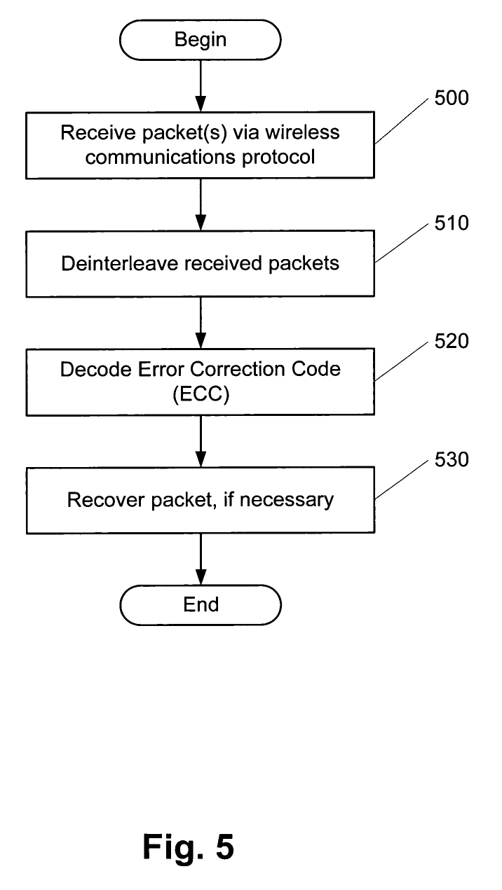

FIG. 5 is a flow diagram of one embodiment of a technique for application of forward error correction (FEC) to a packet to be received via a wireless transmission protocol. One or more packets may be received from a wireless source device, 500. In one embodiment, the packet(s) may be received according to IEEE 802.11 standards; however, other transmission standard may also be supported.

The packet(s) may be deinterleaved to restore the original packet, 510. The ECC may be decoded, 520. Data may be recovered/restored using the ECC, if necessary, 530. Thus, the ECC data may be applied to IEEE 802.11 transmitted data (or other wireless protocols that do not support FEC) to provide a more reliable transport mechanism than use of the standard protocol alone.

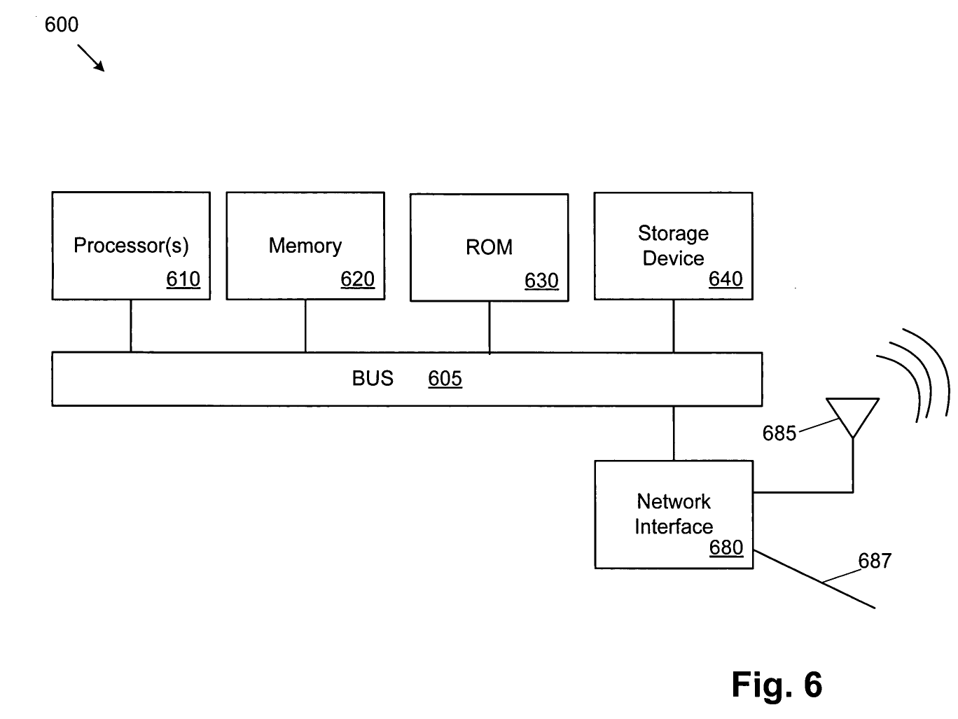

FIG. 6 is a block diagram of one embodiment of an electronic system. The electronic system illustrated in FIG. 6 is intended to represent a range of electronic systems (either wired or wireless) including, for example, a wireless access point. Alternative electronic systems may include more, fewer and/or different components.

Electronic system 600 includes bus 605 or other communication device to communicate information, and processor 610 coupled to bus 605 that may process information. While electronic system 600 is illustrated with a single processor, electronic system 600 may include multiple processors and/or co-processors. Electronic system 600 further may include random access memory (RAM) or other dynamic storage device 620 (referred to as main memory), coupled to bus 605 and may store information and instructions that may be executed by processor 610. Main memory 620 may also be used to store temporary variables or other intermediate information during execution of instructions by processor 610.

Electronic system 600 may also include read only memory (ROM) and/or other static storage device 630 coupled to bus 605 that may store static information and instructions for processor 610. Data storage device 640 may be coupled to bus 605 to store information and instructions. Data storage device 640 such as a magnetic disk or optical disc and corresponding drive may be coupled to electronic system 600.

Electronic system 600 further may include network interface(s) 680 to provide access to a network, such as a local area network. Network interface(s) 680 may include, for example, a wireless network interface having antenna 685, which may represent one or more antenna(e). Network interface(s) 680 may also include, for example, a wired network interface to communicate with remote devices via network cable 687, which may be, for example, an Ethernet cable, a coaxial cable, a fiber optic cable, a serial cable, or a parallel cable.

In one embodiment, network interface(s) 680 may provide access to a local area network, for example, by conforming to IEEE 802.11b and/or IEEE 802.11g standards. Other wireless network interfaces and/or protocols can also be supported.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method of applying forward error correction to a packet to be transmitted via a wireless network comprising:
segmenting the packet into two or more fragments;
applying a forward error correction (FEC) code to the two or more fragments including generation of FEC overhead to be transmitted with the two or more fragments; and
interleaving segments of the two or more fragments to generate two or more error-protected packets.

2. The method of claim 1 further comprising transmitting the two or more error-protected packets via a wireless network interface.

3. The method of claim 1 wherein the FEC is applied at a media access control (MAC) network layer.

4. The method of claim 1 wherein the two or more segments carry multimedia data.

5. The method of claim 1 wherein the packet is received via a wired network connection.

6. The method of claim 1 wherein the interleaving comprises interleaving the two or more segments on a byte-by-byte basis.

7. The method of claim 6 wherein the interleaved data is transmitted according to an IEEE 802.11 standard.

8. The method of claim 7 wherein the packets comprise at least on header having FEC information.

9. An article comprising a computer-readable medium having stored thereon instructions to implement a method of applying forward error correction to a packet to be transmitted via a wireless network, wherein the instructions, when executed by one or more processors:
segment the packet into two or more fragments;
apply a forward error correction (FEC) code to the two or more fragments including generation of FEC overhead to be transmitted with the two or more fragments; and
interleave segments of the two or more fragments to generate two or more error-protected packets.

10. The article of claim 9 further comprising instructions that, when executed, cause the one or more processors to transmit the two or more error-protected packets via a wireless network interface.

11. The article of claim 9 wherein the FEC is applied at a media access control (MAC) network layer.

12. The article of claim 9 wherein the two or more segments carry multimedia data.

13. The article of claim 9 wherein the packet is received via a wired network connection.

14. The article of claim 9 wherein the interleaving comprises interleaving the two or more segments on a byte-by-byte basis.

15. The article of claim 14 wherein the interleaved data is transmitted according to an IEEE 802.11 standard.

16. The article of claim 15 wherein the packets comprise at least on header having FEC information.

17. A method comprising:
receiving a plurality of packets of data via a wireless communications medium, wherein the packets each contain a subset of data from a larger packet and error correction code (ECC) data in an interleaved manner;
deinterleaving the data from the packet;
applying the ECC data to recover lost or corrupted data; and
combining the data from the plurality of packets to result in the data from the larger packet.

18. The method of claim 17 wherein the interleaved manner comprises interleaving of the subset of data and ECC data for a packet on a byte-by-byte basis.

19. The method of claim 18 wherein the interleaved data is transmitted according to an IEEE 802.11 standard.

20. An article comprising a computer-readable medium having stored thereon instructions to implement a method of receiving a plurality of packets transmitted via a wireless communications link having had applied a forward error correction (FEC) to the packets, wherein the instructions, when executed by one or more processors:
receive the plurality of packets, wherein the packets each contain a subset of data from a larger packet and error correction code (ECC) data in an interleaved manner;
deinterleave the data from the packet;
apply the ECC data to recover lost or corrupted data; and
combine the data from the plurality of packets to result in the data from the larger packet.

21. The article of claim 20 wherein the interleaved manner comprises interleaving of the subset of data and ECC data for a packet on a byte-by-byte basis.

22. The article of claim 21 wherein the interleaved data is transmitted according to an IEEE 802.11 standard.

23. A system comprising:
one or more substantially omnidirectional antennae;
a network interface to be coupled with a wired network medium to receive a packet of data;
a processor coupled with the network interface and the one or more antennae to segment the packet into two or more fragments, to apply a forward error correction (FEC) code to the two or more fragments including generation of FEC overhead to be transmitted with the two or more fragments, to interleave segments of the two or more fragments to generate two or more error-protected packets, and to cause the two or more error-protected packets to be transmitted via the one or more antennae.

24. The system of claim 23 wherein the FEC is applied at a media access control (MAC) network layer.

25. The system of claim 23 wherein the two or more segments carry multimedia data.

26. The system of claim 23 wherein the interleaving comprises interleaving the two or more segments on a byte-by-byte basis.

27. The system of claim 26 wherein the interleaved data is transmitted according to an IEEE 802.11 standard.

28. The system of claim 27 wherein the packets comprise at least one header having FEC information.

29. A wireless communication device comprising a media access controller circuit to apply forward error correction to a packet to be transmitted over a wireless network by segmenting the packet into two or more fragments, applying a forward error correction (FEC) code to the two or more fragments including generation of FEC overhead to be transmitted with the two or more fragments, and interleaving segments of the two or more fragments to generate two or more error-protected packets.

30. The wireless communication device of claim 29 wherein the interleaving comprises interleaving the two or more segments on a byte-by-byte basis.

31. The wireless communication device of claim 30 wherein the interleaved data is transmitted according to an IEEE 802.11 standard.

32. The wireless communication device of claim 31 wherein the packets comprise at least on header having FEC information.
